(19) United States
(12) Patent Application Publication
(10) Pub. No.: US 2005/0278537 A1
(43) Pub. Date: Dec. 15, 2005

(54) Logging off a user from a website

(76) Inventors: Dustin Kirkland, Austin, TX (US); Liliana Orozco, Del Valle, TX (US); Kimberly DaShawn Simon, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 10/865,346

(22) Filed: Jun. 10, 2004

(51) Int. Cl. H04K 1/00; H04L 9/00

(52) U.S. Cl. 713/182

(57) ABSTRACT

Methods, systems, and computer program products are described for logging off a user from a website, including detecting through a browser a predefined exit channel for a website; detecting a user's leaving the website outside the predefined exit channel; and guiding browser operation toward the predefined exit channel.

### BACKGROUND OF THE INVENTION

1. Field of the Invention

The field of the invention is data processing, or, more specifically, methods, systems, and products for logging off a user from a website.

2. Description of Related Art

In order to improve a user's experience while interacting through a browser with a website on a web server, a website often gathers personal information about the user, security information, and other stateful information useful in conducting interactions. Such information may be stored in cookies on the client side, databases on the server side, session objects on the server side or the client side, or even in URL-encoded data in the communications stream between a browser and a web server.

Maintenance of stateful information on a website for a user logon session may include security functions. That is, some systems according to embodiments of the present invention maintain stateful information unrelated to security. Other systems include security data and security functions in websites having predefined exit channels. Such security data and security functions can include, for example, authentication and authentication data, logon identifications, user names or client names, personal identification numbers (“PINs”), passwords, Kerberos tokens, privacy and encryption data, public keys, private keys, shared secret keys, digital signatures in support of message integrity, and so on, as will occur to those of skill in the art.

Websites often provide orderly exit procedures, referred to in this specification as ‘predefined exit channels,’ that remove such information when it is no longer presently needed or store such information until it is needed again during another logon session. Such predefined exit channels may include a ‘Sign Out’ link or button on a web page, for example, that invokes a URL identifying server side functionality that deletes temporarily stored security data, logon session data, or other stateful information about the user or the user's interactions through a browser with the website. Many users, however, neglect to exit the website through its predefined exit channel. A user may not know or understand the value of the predefined exit channel, or a user may simply browse off to another website and simply forget to use the predefined exit channel.

Leaving the website outside its predefined exit channel risks leaving security data and other stateful data available in computer memory but unattended through a timeout period. Leaving stateful session data available in computer memory when it should be deleted or securely stored represents security risks as well as an inefficient use of computer resources.

### SUMMARY OF THE INVENTION

Methods, systems, and computer program products are described for logging off a user from a website, including detecting through a browser a predefined exit channel for a website; detecting a user's leaving the website outside the predefined exit channel; and guiding browser operation toward the predefined exit channel. In typical embodiments, detecting a predefined exit channel includes searching a page of the website for exit channel identification terms. In typical embodiments, detecting a predefined exit channel includes applying character recognition to graphic images in a page of the website. In typical embodiments, detecting a predefined exit channel includes recognizing an exit channel identification image in a page of the website.

In typical embodiments, detecting a user's leaving the website outside the predefined exit channel includes detecting a user's exiting the browser. In typical embodiments, detecting a user's leaving the website outside the predefined exit channel includes detecting a user's invocation of a hyperlink to a web location outside the website. In typical embodiments, detecting a user's leaving the website outside the predefined exit channel includes detecting a user's invocation of a hyperlink to a web page without the predefined exit channel.

In typical embodiments, each page of the website may have metadata identifying a particular predefined exit channel, and detecting a user's leaving the website outside the predefined exit channel may include detecting a user's invocation of a hyperlink to a web page having no metadata identifying the particular predefined exit channel.

In typical embodiments, guiding browser operation to the predefined exit channel includes prompting the user to exit the website through the predefined exit channel. In typical embodiments, guiding browser operation to the predefined exit channel includes automatically exiting the website through the predefined exit channel. Typical embodiments also include listing websites having predefined exit channels, where the website is a listed website.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a system diagram illustrating an exemplary data processing system capable of logging off a user from a website.

FIG. 2 sets forth a block diagram of automated computing machinery comprising a computer useful for logging off a user from a website.

FIG. 3 sets forth a flow chart illustrating an exemplary method for logging off a user from a website.

FIG. 4 is a line drawing illustrating an exemplary graphical user interface (‘GUI’) of a browser.

### DETAILED DESCRIPTION OF EXEMPLARY EMBODIMENTS

### Introduction

The present invention is described to a large extent in this specification in terms of methods for logging off a user from a website. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definitions

“Anchor element” refers to a markup language element that identifies and implements a ‘link’ or ‘web link’ or ‘hyperlink.’ Links are the basic hypertext construct, the central function of the web. A common example form of an anchor element is:
<a href=“\\SrvrX\DocY”>Press Here For Document Y</a>
   This example anchor element includes a start tag <a>, and end tag </a>, an href attribute that identifies the target of the link as a document named ‘DocY’ on a web server named ‘SrvrX,’ and an anchor. The “anchor” is the display text that is set forth between the start tag and the end tag. That is, in this example, the anchor is the text “Press Here For Document Y.” In typical usage, the anchor is displayed in highlighting, underscored, inverse, specially colored, or some other fashion setting it apart from other screen text and identifying it as an available hyperlink. In addition, the screen display area of the anchor is sensitized to user interface operations such as GUI pointer operations such as mouseclicks. In typical operation, a user points to the anchor with a mouse pointer or other GUI pointer, clicks on the anchor to invoke the link, and the browser then retrieves and displays Document Y from server SrvrX. The “anchor element” is the entire markup from the start tag to the end tag.

“Browser,” as the term is used in this specification, generally means a web browser, a software application for locating, requesting, retrieving, and displaying computer resources in the form of static or dynamic web pages or server-side scripting output. Browsers typically comprise both a markup language interpreter, web page display routines, and a data communications client capable of communications in a protocol supporting markup languages, HTTP, HDTP, WAP, and so on. Browsers today typically can display text, graphics, audio and video. Browsers are operative in any computer capable of data communications including web-enabled devices, wireless web-enabled devices, microcomputers, PDAs, laptops, and so on. Browsers in wireless web-enabled devices often are downsized browsers called “microbrowsers.” Browsers typically support not only HTML (the ‘HyperText Markup Language’), but other markup languages as well, including for example, XML (the ‘extensible Markup Language’), and, in the case of wireless web-enabled devices, WML (the ‘Wireless Markup Language’) and HDML (the ‘Handheld Device Markup Language’).

CGI means “Common Gateway Interface,” a standard technology for data communications of resources between web servers and web clients. More specifically, CGI provides a standard interface between servers and server-side ‘gateway’ programs which administer actual reads and writes of data to and from files systems and databases. The CGI interface typically sends data to gateway programs through environment variables or as data to be read by the gateway programs through their standard inputs. Gateway programs typically return data through standard output. It is typically a gateway program that provides a MIME type in a return message header advising a server, and eventually therefore a browser or other communications client, of the type of data returned from CGI gateway programs. A “hyperlink,” also referred to as “link” or “web link” is a reference to a resource name or network address which when invoked allows the named resource or network address to be accessed. Often the hyperlink identifies a network address at which is stored a web page. As used here, “hyperlink” is a broader term than “HTML anchor element.” Hyperlinks include links effected through anchors as well as URIs invoked through ‘back’ buttons or ‘forward’ buttons on browsers, which do not involve anchors. Hyperlinks include URIs typed into address fields on browsers and invoked by a ‘Go’ button, also not involving anchors. In addition, although there is a natural tendency to think of hyperlinks as retrieving web pages, their use is broader than that. In fact, hyperlinks access “resources” generally available through hyperlinks including not only web pages but many other kinds of data and server-side script output as well.

“Network” is used in this specification to mean any networked coupling for data communications among computers or computer systems. Examples of networks useful with the invention include intranets, extranets, internets, local area networks, wide area networks, and other networks as will occur to those of skill in the art.

“Resource” means any aggregation of information administered over networks by various embodiments of the present invention. Network communications protocols generally, for example, HTTP, transmit resources, not just files. A resource is an aggregation of information capable of being identified by a URL or URL. In fact, the ‘R’ in ‘URL’ is ‘Resource.’ The most common kind of resource is a file, but resources include dynamically-generated query results, the output of a CGI scripts, Java servlets, dynamic server pages, Java server pages, documents available in several languages, and so on. It may sometimes be useful to think of a resource as similar to a file, but more general in nature. Files as resources include web pages, graphic image files, video clip files, audio clip files, files of data having any MIME type, and so on. As a practical matter, most HTTP resources are currently either files or server-side script output. Server side script output includes output from CGI programs, Java servlets, Active Server Pages, Java Server Pages, and so on.

“Server” in this specification refers to a computer or device comprising automated computing machinery on a network that manages network resources. A “web server” in particular is a server that communicates with browsers by means of data communications protocols supporting hyperlinks, HTTP, HDTP, WAP, and so on, for example.

A “URL” or “Universal Resource Identifier” is an identifier of a named object in any namespace accessible through a network. URIs are functional for any access scheme, including for example, the File Transfer Protocol or “FTP,” Gopher, and the web. A URL as used in typical embodiments of the present invention usually includes an internet protocol address, or a domain name that resolves to an internet protocol address, identifying a location where a resource, particularly a web page, a CGI script, or a servlet, is located on a network, usually the Internet. URLs directed to particular resources, such as particular HTML files, JPEG files, or MPEG files, typically include a path name or file name locating and identifying a particular resource in a file system coupled to a network. To the extent that a particular resource, such as a CGI file or a servlet, is executable, for example to store or retrieve data, a URL often includes query parameters, or data to be stored, in the form of data encoded into the URL. Such parameters or data to be stored are referred to as ‘URL encoded data.’

“URL encoded data” is data packaged in a URL for data communications. In the case of HTTP communications, the HTTP GET and POST functions are often used to transmit URL encoded data. In this context, it is useful to remember that URIs do more than merely request file transfers. URIs identify resource on servers. Such resource may be files having filenames, but the resources identified by URIs also include, for example, queries to databases. Results of such queries do not necessarily reside in files, but they are nevertheless data resources identified by URIs and identified by a search engine and query data that produce such resources. An example of URL encoded data is:
http://www.foo.com/cgi-bin/MyScript.cgi?field1=value1&field2=value2
   This is an example of URL encoded data, which is how HTML forms typically are submitted over the web using HTTP GET request messages. This method using the GET message is useful when the amount of data to be encoded is fairly small. For larger amounts of data, it is more common to use HTTP POST messages for form submissions.

More specifically, the entire example above is a URL bearing encoded data, and the encoded data is the string “field1=value1&field2=value2.” The encoding method is to string field names and field values separated by ‘&’ and “=” with spaces represented by ‘+.’ There are no quote marks or spaces in the string. Having no quote marks, spaces are encoded with ‘+.’ For example, if an HTML form has a field called “name” set to “Lucy”, and a field called “neighbors” set to “Fred & Ethel”, the data string encoding the form would be:
name=Lucy&neighbors=Fred+%26+Ethel
   “World Wide Web,” or more simply “the web,” refers to a system of internet protocol (“IP”) servers that support specially formatted documents, documents formatted in markup languages such as HTML, XML, WML, or HDML. The term “Web” is used in this specification also to refer to any server or connected group or interconnected groups of servers that implement data communications protocols in support of URLs and documents in markup languages, including, for example, the HyperText Transport Protocol (“HTTP”), the Handheld Device Transport Protocol (“HDTP”), the Wireless Access Protocol (“WAP”), and so on as will occur to those of skill in the art.

### Logging Off a User from a Website

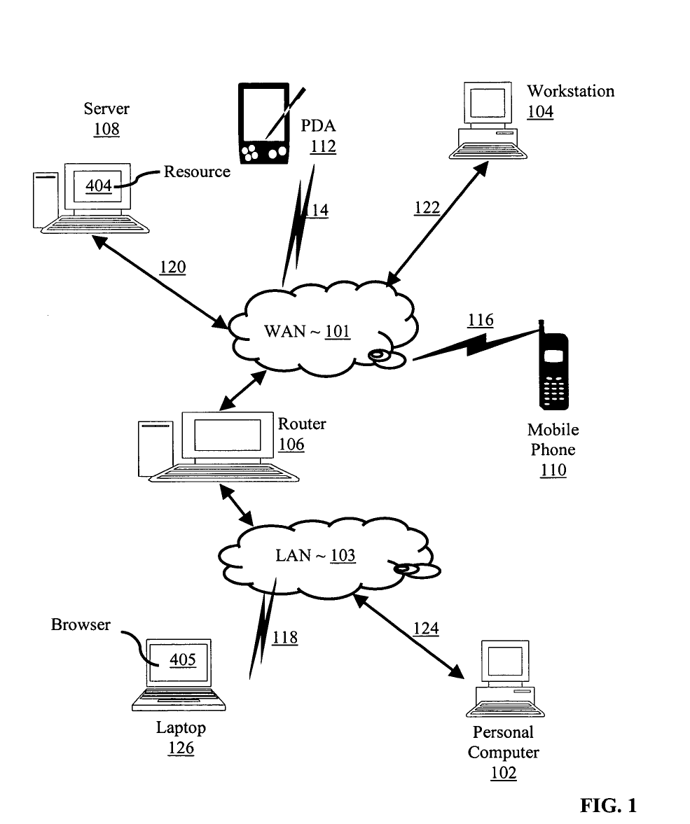

Exemplary methods, systems, and products for logging off a user from a website are now explained with reference to the accompanying drawings, beginning with FIG. 1. FIG. 1 is a system diagram illustrating an exemplary data processing system capable of logging off a user from a website according to embodiments of the present invention. The system of FIG. 1 includes a number of computers connected for data communications in networks. Each of the computers of the system of FIG. 1 may have a browser (405) installed upon it, and each of the computers of FIG. 1 may operate to log off a user from a website according to embodiments of the present invention by detecting through a browser a predefined exit channel for a website, detecting a user's leaving the website outside the predefined exit channel, and guiding browser operation toward the predefined exit channel.

The data processing system of FIG. 1 includes wide area network (“WAN”) (101) and local area network (“LAN”) (103). The network connection aspect of the architecture of FIG. 1 is only for explanation, not for limitation. In fact, systems for logging off a user from a website according to embodiments of the present invention may be connected as LANs, WANs, intranets, internets, the Internet, webs, the World Wide Web itself, or other connections as will occur to those of skill in the art. Such networks are media that may be used to provide data communications connections between various devices and computers connected together within an overall data processing system.

In the example of FIG. 1, router (106) implements a gateway or bridge between LAN (103) and WAN (101), and server (108) makes available a computer resource (404). Server (108) may be any computer capable of accepting a request for a resource and responding by providing the resource to the requester. One example of such a server is an HTTP (‘HyperText Transport Protocol’) server or ‘web server.’ Resource (404) may be any computer resource whose location may be specified by a URL, web pages, CGI scripts, Java servlets, and so on.

In the example of FIG. 1, several exemplary devices including a PDA (112), a computer workstation (104), a mobile phone (110), and server (108) are connected to WAN (101). Network-enabled mobile phone (110) connects to WAN (101) through wireless link (116), and PDA (112) connects to network (101) through wireless link (114). In the example of FIG. 1, server (108) connects through wireline connection (120) to WAN (101), and computer workstation (104) connects through wireline connection (122) to WAN (101). Laptop (126) connects through wireless link (118) to LAN (103), and personal computer (102) connects through wireline connection (124) to LAN (103). In the system of FIG. 1, exemplary devices (112, 104, 110, 126, and 102) each may operate a browser and each is capable of logging off a user from a website in accordance with the present invention by detecting through a browser a predefined exit channel for a website, detecting a user's leaving the website outside the predefined exit channel, and guiding browser operation toward the predefined exit channel.

The arrangement of devices making up the exemplary system illustrated in FIG. 1 is for explanation, not for limitation. Data processing systems useful to log off a user from a website according to various embodiments of the present invention may include additional servers, routers, other devices, and peer-to-peer architectures, not shown in FIG. 1, as will occur to those of skill in the art. Networks in such data processing systems may support many data communications protocols, including for example TCP/IP, HTTP, WAP, HDTP, and others as will occur to those of skill in the art. Various embodiments of the present invention may be implemented on a variety of hardware platforms in addition to those illustrated in FIG. 1.

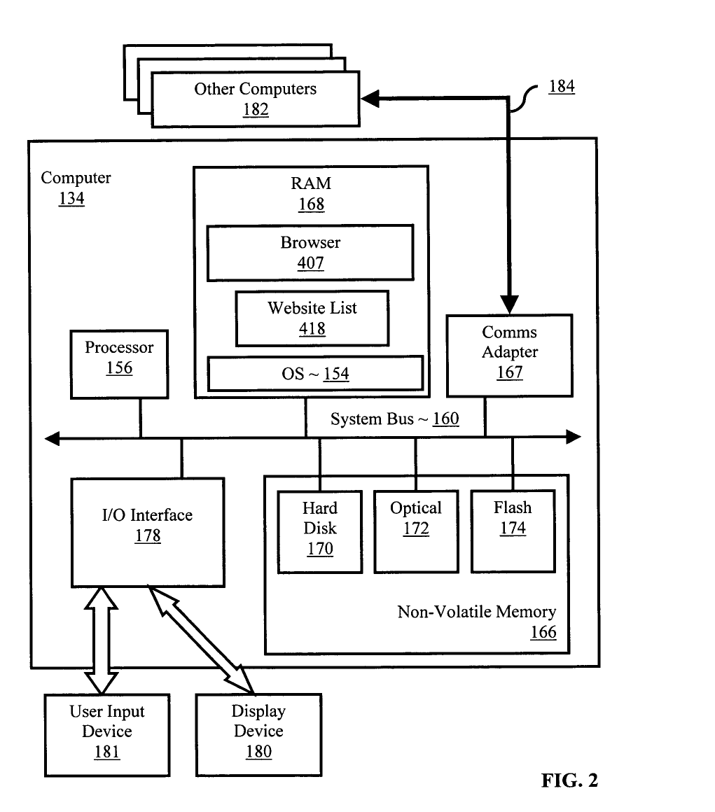

As mentioned above, logging off a user from a website in accordance with the present invention is generally implemented with computers, that is, with automated computing machinery. For further explanation, FIG. 2 sets forth a block diagram of automated computing machinery comprising a computer (134) useful for logging off a user from a website according to embodiments of the present invention. The computer (134) of FIG. 2 includes at least one computer processor (156) or ‘CPU’ as well as random access memory (168) (“RAM”). Stored in RAM (168) is a browser (407) and a list (418) of websites having predefined exit channels. Also stored in RAM (168) is an operating system (154). Operating systems useful in computers according to embodiments of the present invention include Unix, Linux, Microsoft NT™, and many others as will occur to those of skill in the art. Operating system (154) in the example of FIG. 2 is shown in RAM (154), but many components of an operating system typically are stored in non-volatile memory (166) also.

The computer (134) of FIG. 2 includes non-volatile computer memory (166) coupled through a system bus (160) to processor (156) and to other components of the computer. Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary computer (134) of FIG. 2 includes a communications adapter (167) for implementing connections for data communications (184), including connections through networks, to other computers (182), including servers, clients, and others as will occur to those of skill in the art. Communications adapters implement the hardware level of connections for data communications through which local devices and remote devices or servers send data communications directly to one another and through networks. Examples of communications adapters useful for logging off a user from a website according to embodiments of the present invention include modems for wired dial-up connections, Ethernet (IEEE 802.3) adapters for wired LAN connections, and 802.11b adapters for wireless LAN connections.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

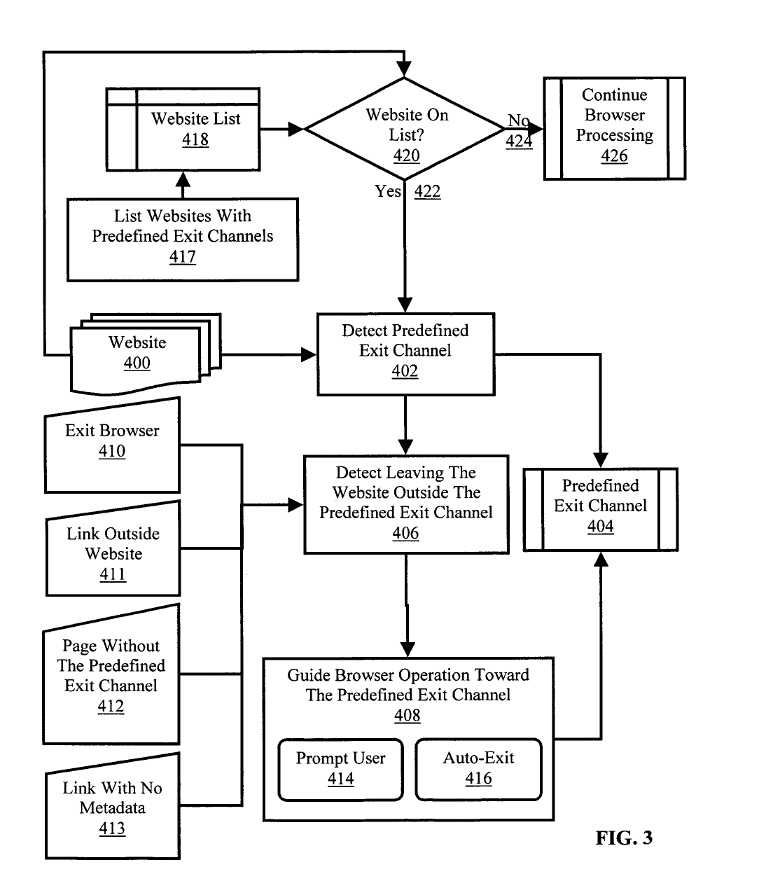

For further explanation, FIG. 3 sets forth a flow chart illustrating an exemplary method for logging off a user from a website that includes detecting (402) through a browser a predefined exit channel (404) for a website, detecting (406) a user's leaving the website outside the predefined exit channel, and guiding (408) browser operation toward the predefined exit channel.

In the method of FIG. 3, detecting (402) a predefined exit channel may be carried out by searching a page of the website for exit channel identification terms. Exit channel identification terms often are implemented as terms in anchor text that identify exit channels. The following anchor, for example:
<a href=“http//www.servrX.com/cgiScripts/signoff.cgi>Sign Off</a>
   displays on a browser screen the text “Sign Off” as a hyperlink. Invoking that hyperlink executes on the web server identified as “servrX.com” a CGI script named “signoff.cgi.” Similarly, invoking the hyperlink defined by this anchor:
<a href=“http//www.servrX.com/servlets/logoff>Log Off</a>
   displays “Log Off” as a hyperlink and executes a Java server page named “signoff.”

Each such anchor is included in a web page of a website (400), and detecting (402) a predefined exit channel in such a web page may be carried out by scanning through the page searching for terms in anchor text that typically identifies predefined exit channels. Such terms include, for example, “Sign Out,” “Sign Off,” “Log Out,” “Log Off,” “Exit,” “Quit,” and so on, as will occur to those of skill in the art.

Additionally in the method of FIG. 3, detecting (402) a predefined exit channel may be carried out by applying character recognition to graphic images in a page of the website or by recognizing an exit channel identification image in a page of the website. In this sense, character recognition and image recognition are forms of pattern recognition that include respectively identifying graphic images of terms identifying predefined exit channels and iconographic identifications of predefined exit channels.

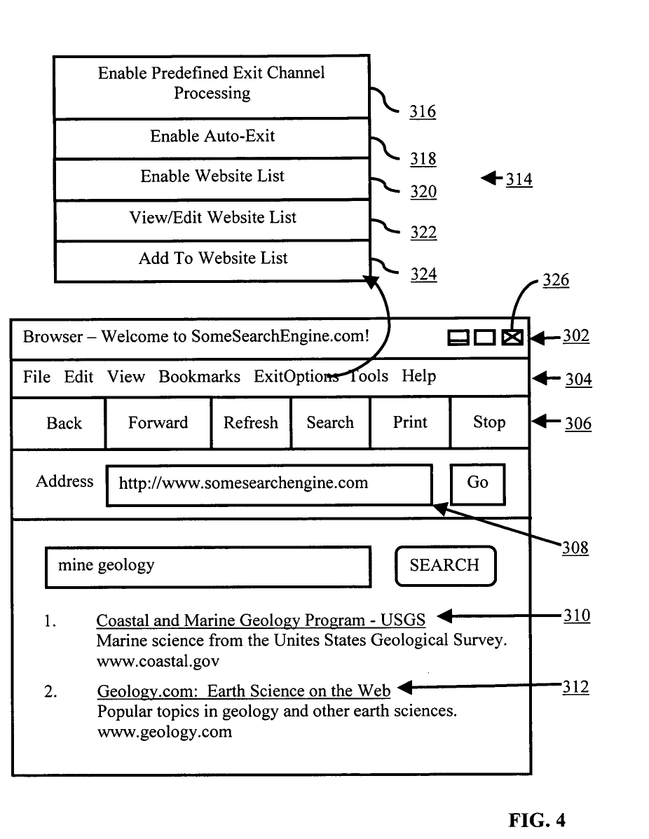

In the method of FIG. 3, detecting (406) a user's leaving the website outside the predefined exit channel may be carried out by detecting a user's exiting (410) the browser, that is, exiting the browser without exiting the website through its predefined exit channel. Exiting a browser is carried out by selecting a menu item for ‘close’ or ‘exit’ from a pull down menu area of browser controls such as the one shown at reference (304) on FIG. 4, where such menu items typically may be found under the ‘File’ option. Alternatively, exiting a browser may be implemented by operating an operating system GUI control for closing the operating system window in which the browser is running. Such an operating system GUI control is shown, for example, at reference (326) on FIG. 4.

In the method of FIG. 3, detecting (406) a user's leaving the website outside the predefined exit channel may be implemented by detecting a user's invocation of a hyperlink to a web location outside the website (411). A ‘website’ as the term is used in this specification includes a scope or quantity of computer resources accessible through the World Wide Web for a web server that maintains stateful information regarding users, clients, other hosts. A website may be all the resources associated with a domain name or a subset of the resources identified by a domain name. A website that is all the resource identified by a domain name may be identified by a URL containing only a domain name, e.g., www.webSiteX.com. A website that is a subset of the resources identified by a domain name may be identified by a URL containing both a domain name and a file system pathname, e.g., www.webSiteX.com/logonRegion.

Detecting a user's invocation of a hyperlink to a web location outside a website may be carried out by storing in computer memory the URL that identifies the website when the user logs on to the website and comparing subsequently invoked URLs with the stored URL to determine whether such subsequently invoked URLs point to resources within the website. When a user logs on to the website identified as www.webSiteX.com, for example, and subsequently invokes a URL pointing to www.webSiteX.com/myWorkArea, this exemplary method treats resources from www.webSiteX.com/myWorkArea as part of the website to which the user is currently logged on. Invoking a URL pointing to www.webSiteX.com/myWorkArea therefore is not detected as a user's invocation of a hyperlink to a web location outside the website identified as www.webSiteX.com. Invoking a URL to www.google.com, however, because www.google.com does not point to a subset of the resources at www.webSiteX.com, is detected as a user's invocation of a hyperlink to a web location outside the website identified by www.webSiteX.com and is therefore also detected as a user's leaving the website outside its predefined exit channel.

Additionally in the method of FIG. 3, detecting (406) a user's leaving the website outside the predefined exit channel may include detecting a user's invocation of a hyperlink to a web page without the predefined exit channel (412). As mentioned above, the presence of a predefined exit channel may be indicated by anchor text, graphic representations of text, or iconographic identifications of predefined exit channels. As described below, the presence or availability of a predefined exit channel in a web page may be indicated by metadata in a web page header or in other metadata in a web page. Detecting a user's invocation of a hyperlink to a web page without the predefined exit channel, therefore, may be carried out, when a user invokes a new hyperlink, by saving the previous web page temporarily, downloading the new web page identified by the new hyperlink, detecting whether the new web page has the same predefined exit channel as the previous page, and, if it does not, detecting that fact as a user's leaving the website outside the predefined exit channel. Detecting whether the new web page has the same predefined exit channel as the previous page may be carried out by scanning the new web page, before displaying it, for text terms, graphic images of text, a graphic icon identifying a predefined exit channel, or metadata. If the new web page is found to have the same predefined exit channel, the browser in this example discards the old web page, displays the new one, and continues processing. If the new web page is found not to have the same predefined exit channel, the browser detects (406) a user's leaving the website outside the predefined exit channel and guides (408) browser operations toward the predefined exit channel. Guiding the browser toward the predefined exit channel may include automatically invoking the exit channel or prompting the user to choose whether to return to the previous page for an orderly exit through the predefined exit channel or continue processing without exiting through the predefined exit channel.

In the method of FIG. 3, each page of a website (400) may contain metadata identifying a particular predefined exit channel, and detecting (406) a user's leaving the website outside the predefined exit channel may be accomplished by detecting a user's invocation of a hyperlink to a web page having no metadata identifying the particular predefined exit channel (413). Metadata may identify a particular predefined exit channel as shown here, for example, in HTML:

<HTML>

<HEAD>

<META name=“PredefinedExitChannel”

content=“Log Off”>

</HEAD>
<BODY>

... ... ...
<a href=“www.servrX.com/cgi/logoff.cgi”>Log Off</a>
... ... ...

</BODY>

</HTML>

In this example, a metadata element named “PredefinedExitChannel” is used to identify a particular predefined exit channel, the anchor element containing the anchor text “Log Off.” In this example, the presence of the metadata element affirmatively signifies that the web page contains a predefined exit channel, and the content of the metadata element affirmatively identifies the particular anchor element that implements the predefined exit channel.

In this example, detecting a user's invocation of a hyperlink to a web page having no metadata identifying a particular predefined exit channel may be carried out, when a user invokes a new hyperlink, by saving the previous web page temporarily, downloading the new web page identified by new hyperlink, scanning the web page, the HTML, for metadata identifying a particular predefined exit channel, and, if there is no such metadata in the page, detecting that fact as a user's leaving the website outside the predefined exit channel. Detecting whether the new web page has a predefined exit channel may be carried out by scanning the new web page, before displaying it, for the presence of metadata identifying a particular predefined exit channel. If the new web page is found to have metadata identifying a particular predefined exit channel, the browser in this example discards the old web page, displays the new one, and continues processing. If the new web page is found not to have metadata identifying a particular predefined exit channel, the browser detects (406) a user's leaving the website outside the predefined exit channel and guides (408) browser operations toward the predefined exit channel. Guiding the browser toward the predefined exit channel may include automatically invoking the exit channel or prompting the user to choose whether to return to the previous page for an orderly exit through the predefined exit channel or continue processing without exiting through the predefined exit channel.

In fact, in the method of FIG. 3 generally, guiding (408) browser operation to a predefined exit channel may include prompting (414) the user to exit the website through the predefined exit channel. When, for example, a browser detects as described above that a newly invoked hyperlink or URL points to a new web page outside the scope of a website logon or to a new web page without the predefined exit channel, the browser may be programmed to prompt the user:
Please Exit The Current Website
Through Its Predefined Exit Channel
   and give the user the option to return to exit the current website through its predefined exit channel or continue to the next web page without exiting through the predefined exit channel.

Alternatively in the method of FIG. 3, guiding (408) browser operation to the predefined exit channel may be implemented by automatically exiting (416) the website through the predefined exit channel. That is, rather than prompting the user to decide whether to use a predefined exit channel, the browser is configured with a setup parameter or flag indicating that when a predefined exit channel for a website is detected, it is always to be used when a user is leaving the website. In the presence of a predefined exit channel like the one shown above in HTML, for example, having this predefined exit channel:
<a href=“www.servrX.com/cgi/logoff.cgi”>Log Off</a>,
   the browser is programmed, upon detecting a user's leaving the current website outside the predefined exit channel, to automatically invoke the URL www.servrX.com/cgi/logoff.cgi without prompting the user to choose whether to do so. In this example, in order to reduce the risk of confusion to the user, the browser optionally may notify the user what is happening, but the browser give the user no option to exit the website outside its predefined exit channel.

The example of FIG. 3 also includes listing (417, 418) websites having predefined exit channels, wherein the website comprises a listed website. Listing websites having predefined exit channels provides a method of greater assurance for detecting the presence of a predefined exit channel in a website. The list (418) may optionally include not only the URLs identifying websites with predefined exit channels, but also may include URLs identifying the predefined exit channels themselves. For a browser improved to maintain a list of websites having predefined exit channels, the method of FIG. 3 includes determining (420) whether a website is on the list when a URL to a website is invoked. If the URL to the new page is on the list (422), operation continues with detecting the predefined exit channel, detecting a user's leaving the website outside the predefined exit channel, guiding browser operation toward the predefined exit channel, and so on. If the URL to the new page is not on the list (424), normal browser operations continue (426) with no regard to any predefined exit channel for the current website.

For further explanation, FIG. 4 is a line drawing illustrating an exemplary graphical user interface (‘GUI’) of a browser. The browser of FIG. 4 is an example of a software product improved according to embodiments of the present invention, that is, programmed at the source code level, modified with a plug-in, or otherwise modified in a manner that will occur to those of skill in the art, to detect a predefined exit channel for a website, detect a user's leaving the website outside the predefined exit channel, and guide browser operation toward the predefined exit channel. The example of FIG. 4 is taken as a browser for convenience of explanation, not for limitation. In fact, many software programs capable of data communications may be improved according to embodiments of the present invention to detect a predefined exit channel for a website, detect a user's leaving the website outside the predefined exit channel, and guide browser operation toward the predefined exit channel. The term ‘browser’ is used in this specification to refer to any data communications software application program capable of operating according to embodiments of the present invention.

The browser of FIG. 4, as depicted, has been operated to point to a website named “SomeSearchEngine.com,” as shown in the title bar of the browser display (302). The browser of FIG. 4 includes a GUI toolbar (306) with a Back button, a Forward button, and buttons for refreshing the display, searching, printing, and stopping web page retrievals. The browser of FIG. 4 also includes a horizontal menu (304) containing the menu items File, Edit, View, Bookmark (called ‘Favorites’ on some browsers), ExitOptions, Tools, and Help.

The exemplary browser of FIG. 4 supports several ways to invoke URLs. The exemplary browser of FIG. 4 includes an address bar (308), and invoking the URL identifying the displayed web page may be carried out by entering the URL in a browser's address bar (308) and invoking the GUI Go button in the address bar with a mouseclick or carriage return. The displayed web page also includes hyperlinks (310 and 312) to resources identified and returned by the website SomeSearchEngine.com in response to a search query ‘mine geology.’ A ‘hyperlink’ is a reference to a URL which when invoked requests access to a resource identified by the URL. The term ‘hyperlink’ in this specification includes links to URLs effected through anchor elements, ‘Back’ and ‘Forward’ buttons on a toolbar (306) in a GUI of a software application program, and by invoking Bookmarks.

An anchor element is a markup language element that identifies and implements a hyperlink. An exemplary form of an anchor element, here expressed in HTML, is:
<a href=“http://www.SrvrX.com\DocY”>Press Here For Document Y</a>
   This example anchor element includes a start tag <a>, an end tag </a>, an href attribute that identifies the target of the link as a document named ‘DocY’ on a web server identified by domain name ‘SrvrX.com,’ and an anchor. The “anchor” is the display text that is set forth between the start tag and the end tag. That is, in this example, the anchor is the text “Press Here For Document Y.” In typical usage, the anchor is displayed in highlighting, underscored, inverse, specially colored, or some other fashion setting it apart from other screen text and identifying it as an available hyperlink. In addition, the screen display area of the anchor is sensitized to user interface operations including GUI pointer operations such as mouseclicks. In typical operation, a user points to the anchor with a mouse pointer or other GUI pointer, clicks on the anchor to invoke the link, and the browser then retrieves and displays the web page identified as ‘DocY’ from server ‘SrvrX.com.’ The ‘anchor element’ is the entire markup from the start tag to the end tag. In the example of FIG. 4, hyperlink (310) is depicted with anchor “Coastland Marine Geology Program —USGS” and hyperlink (312) is depicted with anchor “Geology.com: Earth Science on the Web.”

In the exemplary browser of FIG. 4, the menu entry called ExitOptions is programmed to display a pull-down menu (314) used in support of logging off users from websites according to embodiments of the present invention. In the example of FIG. 4, the pull-down menu (314) includes a menu option (316) to enable browser processing for predefined exit channels according to embodiments of this invention. In addition, the pull-down menu (314) includes an option (318) to enable guiding browser operation to a predefined exit channel by automatically exiting a website through its predefined exit channel without prompting a user with a choice. When option (318) is disabled, guiding browser operation to a predefined exit channel in this example is carried out by prompting the user to exit the website through the predefined exit channel and giving the user a choice whether to do so.

The pull-down menu (314) includes an option (320) to enable processing of predefined exit channels with a list of websites having predefined exit channels. When this option (320) is enabled, browser functions include determining whether a website is on a list of websites having predefined exit channels when a URL to a website is invoked, and, if the URL to the new page is on the list, browser operation continues with detecting the predefined exit channel, detecting a user's leaving the website outside the predefined exit channel, guiding browser operation toward the predefined exit channel, and so on. The pull-down menu (314) includes an option (322) to view or edit the list of websites having predefined exit channels and an option (324) to add a website to the list of websites having predefined exit channels.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method for logging off a user from a website, the method comprising:
detecting through a browser a predefined exit channel for a website;
detecting a user's leaving the website outside the predefined exit channel; and
guiding browser operation toward the predefined exit channel.

2. The method of claim 1 wherein detecting a predefined exit channel further comprises searching a page of the website for exit channel identification terms.

3. The method of claim 1 wherein detecting a predefined exit channel further comprises applying character recognition to graphic images in a page of the website.

4. The method of claim 1 wherein detecting a predefined exit channel further comprises recognizing an exit channel identification image in a page of the website.

5. The method of claim 1 wherein detecting a user's leaving the website outside the predefined exit channel further comprises detecting a user's exiting the browser.

6. The method of claim 1 wherein detecting a user's leaving the website outside the predefined exit channel further comprises detecting a user's invocation of a hyperlink to a web location outside the website.

7. The method of claim 1 wherein detecting a user's leaving the website outside the predefined exit channel further comprises detecting a user's invocation of a hyperlink to a web page without the predefined exit channel.

8. The method of claim 1 wherein:
each page of the website has metadata identifying a particular predefined exit channel; and
detecting a user's leaving the website outside the predefined exit channel further comprises detecting a user's invocation of a hyperlink to a web page having no metadata identifying the particular predefined exit channel.

9. The method of claim 1 wherein guiding browser operation to the predefined exit channel further comprises prompting the user to exit the website through the predefined exit channel.

10. The method of claim 1 wherein guiding browser operation to the predefined exit channel further comprises automatically exiting the website through the predefined exit channel.

11. The method of claim 1 further comprising listing websites having predefined exit channels, wherein the website comprises a listed website.

12. A system for logging off a user from a website, the system comprising:
means for detecting through a browser a predefined exit channel for a website;
means for detecting a user's leaving the website outside the predefined exit channel; and
means for guiding browser operation toward the predefined exit channel.

13. The system of claim 12 wherein means for detecting a predefined exit channel further comprises means for searching a page of the website for exit channel identification terms.

14. The system of claim 12 wherein means for detecting a predefined exit channel further comprises means for applying character recognition to graphic images in a page of the website.

15. The system of claim 12 wherein means for detecting a predefined exit channel further comprises means for recognizing an exit channel identification image in a page of the website.

16. The system of claim 12 wherein means for detecting a user's leaving the website outside the predefined exit channel further comprises means for detecting a user's exiting the browser.

17. The system of claim 12 wherein means for detecting a user's leaving the website outside the predefined exit channel further comprises means for detecting a user's invocation of a hyperlink to a web location outside the website.

18. The system of claim 12 wherein means for detecting a user's leaving the website outside the predefined exit channel further comprises means for detecting a user's invocation of a hyperlink to a web page without the predefined exit channel.

19. The system of claim 12 wherein:
each page of the website has metadata identifying a particular predefined exit channel; and
means for detecting a user's leaving the website outside the predefined exit channel further comprises means for detecting a user's invocation of a hyperlink to a web page having no metadata identifying the particular predefined exit channel.

20. The system of claim 12 wherein means for guiding browser operation to the predefined exit channel further comprises means for prompting the user to exit the website through the predefined exit channel.

21. The system of claim 12 wherein means for guiding browser operation to the predefined exit channel further comprises means for automatically exiting the website through the predefined exit channel.

22. The system of claim 12 further comprising means for listing websites having predefined exit channels, wherein the website comprises a listed website.

23. A computer program product for logging off a user from a website, the computer program product comprising:
a recording medium;
means, recorded on the recording medium, for detecting through a browser a predefined exit channel for a website;
means, recorded on the recording medium, for detecting a user's leaving the website outside the predefined exit channel; and
means, recorded on the recording medium, for guiding browser operation toward the predefined exit channel.

24. The computer program product of claim 23 wherein means, recorded on the recording medium, for detecting a predefined exit channel further comprises means, recorded on the recording medium, for searching a page of the website for exit channel identification terms.

25. The computer program product of claim 23 wherein means, recorded on the recording medium, for detecting a predefined exit channel further comprises means, recorded on the recording medium, for applying character recognition to graphic images in a page of the website.

26. The computer program product of claim 23 wherein means, recorded on the recording medium, for detecting a predefined exit channel further comprises means, recorded on the recording medium, for recognizing an exit channel identification image in a page of the website.

27. The computer program product of claim 23 wherein means, recorded on the recording medium, for detecting a user's leaving the website outside the predefined exit channel further comprises means, recorded on the recording medium, for detecting a user's exiting the browser.

28. The computer program product of claim 23 wherein means, recorded on the recording medium, for detecting a user's leaving the website outside the predefined exit channel further comprises means, recorded on the recording medium, for detecting a user's invocation of a hyperlink to a web location outside the website.

29. The computer program product of claim 23 wherein means, recorded on the recording medium, for detecting a user's leaving the website outside the predefined exit channel further comprises means, recorded on the recording medium, for detecting a user's invocation of a hyperlink to a web page without the predefined exit channel.

30. The computer program product of claim 23 wherein:
each page of the website has metadata identifying a particular predefined exit channel; and
means, recorded on the recording medium, for detecting a user's leaving the website outside the predefined exit channel further comprises means, recorded on the recording medium, for detecting a user's invocation of a hyperlink to a web page having no metadata identifying the particular predefined exit channel.

31. The computer program product of claim 23 wherein means, recorded on the recording medium, for guiding browser operation to the predefined exit channel further comprises means, recorded on the recording medium, for prompting the user to exit the website through the predefined exit channel.

32. The computer program product of claim 23 wherein means, recorded on the recording medium, for guiding browser operation to the predefined exit channel further comprises means, recorded on the recording medium, for automatically exiting the website through the predefined exit channel.

33. The computer program product of claim 23 further comprising means, recorded on the recording medium, for listing websites having predefined exit channels, wherein the website comprises a listed website.
